(19) United States
(12) Patent Application Publication
(10) Pub. No.: US 2021/0270140 A1
(43) Pub. Date: Sep. 2, 2021

(54) An Aerofoil Structure and a Method of Manufacturing an Aerofoil Structure for a Gas Turbine Engine

(71) Applicant: Rolls-Royce plc, London (GB)

(72) Inventor: Giovanni Antonio Marengo, London (GB)

(73) Assignee: Rolls-Royce plc, London (GB)

(21) Appl. No.: 17/258,282

(22) PCT Filed: Jul. 3, 2019
(86) PCT No.: PCT/EP2019/067854

§ 371 Date: Jan. 6, 2021

(30) Foreign Application Priority Data
Jul. 6, 2018 (GB) 1811103.9

(51) Int. Cl. F01D 5/28

(52) U.S. Cl. CPC F01D 5/282; F05D 2220/32; F05D 2300/434; F05D 2240/30; F05D 2230/20

(57) ABSTRACT

The present disclosure relates to a method of manufacturing an aerofoil structure for a gas turbine engine, wherein the aerofoil structure includes a root configured to be received in a rotor disc of the gas turbine engine, the method including:
providing a pre-moulded polymer insert;
adding the polymer insert into a mould for forming the aerofoil structure;
adding a composite constituent into the mould; and
heating the composite constituent in the mould to bond the polymer insert to the composite constituent, the polymer insert being provided at a shoulder of the aerofoil structure root. The composite constituent is pre-impregnated with a resin and heating the composite constituent in the mould thermosets the resin. Heating the composite constituent in the mould to bond the polymer insert to the composite constituent forms an intermediate part and the method further comprises machining the intermediate part to remove excess material and form the aerofoil structure.

### CROSS-REFERENCE TO RELATED APPLICATIONS

This application is a U.S. National Stage application under 35 U.S.C. § 371 of International Application No. PCT/EP2019/067854, filed Jul. 3, 2019, which claims the benefit of and priority to United Kingdom Application No. GB 1811103.9, filed Jul. 6, 2018, and the present application claims the benefit of the filing date of both of these prior applications, which are incorporated by reference in their entireties.

### TECHNICAL FIELD

The present disclosure relates to an aerofoil structure and a method of manufacturing an aerofoil structure for a gas turbine engine and particularly, but not exclusively, relates to providing a pre-formed insert, which is added into a mould for forming the aerofoil structure so that the insert is provided at a flank of the aerofoil structure root.

### BACKGROUND

Composite fan blades for gas turbine engines are currently moulded using a composite pre-impregnated with a thermosetting resin. A root of the fan blade is inserted in a rotating disc, typically made from titanium, as part of the overall fan module.

The interface between the thermoset material of the fan blade and the titanium alloy of the rotor disc may affect the durability of the fan blade once in service. In order to prevent the wear of the fan blade material, a strip of Vespel® material is currently bonded on a flank of the fan blade root. The Vespel® strip acts as a medium between the titanium rotor disc and the thermoset material of the blade root.

The Vespel® strip is bonded onto the fan blade in a separate operation once the blade root flank has been machined to the required dimensions. This manufacturing process is time consuming and the Vespel® material is expensive.

### BRIEF SUMMARY

According to an aspect there is provided a method of manufacturing an aerofoil structure for a gas turbine engine, wherein the aerofoil structure comprises a root configured to be received in a rotor disc of the gas turbine engine, wherein the method comprises:
providing a pre-formed insert;
adding the insert into a mould for forming the aerofoil structure;
adding a composite constituent into the mould; and
heating the composite constituent in the mould to bond the insert to the composite constituent, the insert being provided at a flank of the aerofoil structure root that faces a shoulder of the rotor disc

Heating the composite constituent in the mould to bond the insert to the composite constituent may form an intermediate part. The method may further comprise machining the intermediate part to remove excess material and form the aerofoil structure. Machining the intermediate part may comprise machining either the insert or the composite constituent or both the insert and the composite constituent.

The composite constituent may be pre-impregnated with a resin and heating the composite constituent in the mould may thermoset the resin.

The melting temperature of the insert may be higher than the melting temperature of the resin.

The composite constituent may comprise carbon fibre pre-impregnated with a resin.

The composite constituent may form an elongate structure extending from the root to a tip of the aerofoil structure.

The method may further comprise adding a further insert into the mould. The insert and further insert may be provided either side of the composite constituent.

The method may further comprise machining the insert prior to adding the insert into the mould. The further insert may also be machined. For example, the method may comprise grit-blasting the insert and/or further insert prior to adding the insert into the mould. The surface of the insert and/or further insert that faces the composite constituent may be grit-blasted. The method may further comprise degreasing the insert and/or further insert prior to adding the insert into the mould.

The method may further comprise adding an adhesive layer between the insert and the composite constituent. The method may further comprise adding an adhesive layer between the further insert and the composite constituent.

The insert may be formed from a polymer, such as polyimide.

According to another aspect there is provided an aerofoil structure manufactured by the above-mentioned method.

According to another aspect there is provided an aerofoil structure for a gas turbine engine, wherein the aerofoil structure comprises a root configured to be received in a rotor disc of the gas turbine engine, wherein the aerofoil structure is formed from a composite constituent and an insert moulded together, the insert being provided at a flank of the aerofoil structure root that faces a shoulder of the rotor disc.

According to another aspect there is provided a method of repairing the above-mentioned aerofoil structure, wherein the method comprises machining the insert to conform to a desired shape.

A gas turbine engine for an aircraft may comprise:
an engine core comprising a turbine, a compressor, and a core shaft connecting the turbine to the compressor; and
a fan located upstream of the engine core, the fan comprising a plurality of the above-mentioned aerofoil structures.

The gas turbine engine may further comprise a gearbox that receives an input from the core shaft and outputs drive to the fan so as to drive the fan at a lower rotational speed than the core shaft.

The turbine may be a first turbine, the compressor may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only be the first core shaft, and not the second core shaft, in the example above). Alternatively, the gearbox may be arranged to be driven by any one or more shafts, for example the first and/or second shafts in the example above.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e. the values may form upper or lower bounds). These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350 cm, 360 cm (around 140 inches), 370 cm (around 145 inches), 380 (around 150 inches) cm or 390 cm (around 155 inches). The fan diameter may be in an inclusive range bounded by any two of the values in the previous sentence (i.e. the values may form upper or lower bounds).

The rotational speed of the fan may vary in use. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

In use of the gas turbine engine, the fan (with associated fan blades) rotates about a rotational axis. This rotation results in the tip of the fan blade moving with a velocity Uₜᵢₚ. The work done by the fan blades 13 on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as fan tip radius at leading edge multiplied by angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (all units in this paragraph being Jkg⁻¹K⁻¹/(ms⁻¹)²). The fan tip loading may be in an inclusive range bounded by any two of the values in the previous sentence (i.e. the values may form upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, or 17. The bypass ratio may be in an inclusive range bounded by any two of the values in the previous sentence (i.e. the values may form upper or lower bounds). The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds).

Specific thrust of an engine may be defined as the net thrust of the engine divided by the total mass flow through the engine. At cruise conditions, the specific thrust of an engine described and/or claimed herein may be less than (or on the order of) any of the following: 110 Nkg⁻¹ s, 105 Nkg⁻¹ s, 100 Nkg⁻¹ s, 95 Nkg⁻¹ s, 90 Nkg⁻¹ s, 85 Nkg⁻¹ s or 80 Nkg⁻¹ s. The specific thrust may be in an inclusive range bounded by any two of the values in the previous sentence (i.e. the values may form upper or lower bounds). Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15 deg C. (ambient pressure 101.3 kPa, temperature 30 deg C.), with the engine static.

In use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds). The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium based metal or an aluminium based material (such as an aluminium-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fibre or aluminium based body (such as an aluminium lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a bladed disk or a bladed ring. Any suitable method may be used to manufacture such a bladed disk or bladed ring. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of descent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be the cruise condition. For some aircraft, the cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to: a forward Mach number of 0.8; a pressure of 23000 Pa; and a temperature of −55 deg C.

As used anywhere herein, “cruise” or “cruise conditions” may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 is a close up sectional side view of an upstream portion of a gas turbine engine;

FIG. 3 is a partially cut-away view of a gearbox for a gas turbine engine;

FIG. 4 is a flowchart depicting a method of manufacturing an aerofoil structure for the gas turbine engine;

FIG. 5 is a partial schematic view of a mould for manufacturing the aerofoil structure;

FIG. 6 is a schematic view of a root of the intermediate part from the mould; and

FIG. 7 is a schematic view of the aerofoil structure when installed in a rotor.

### DETAILED DESCRIPTION

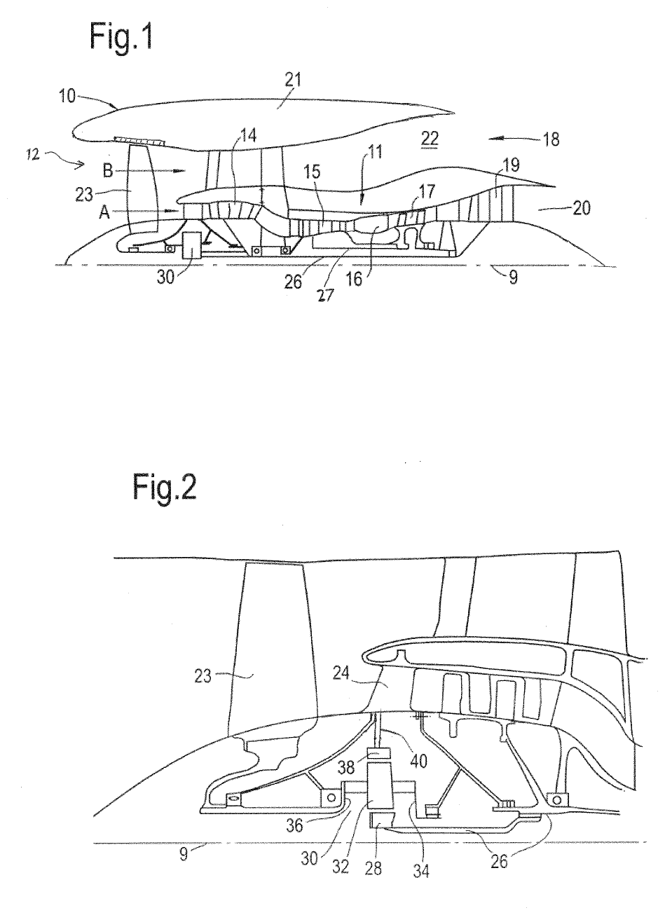

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

An exemplary arrangement for a geared fan gas turbine engine 10 is shown in FIG. 2. The low pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

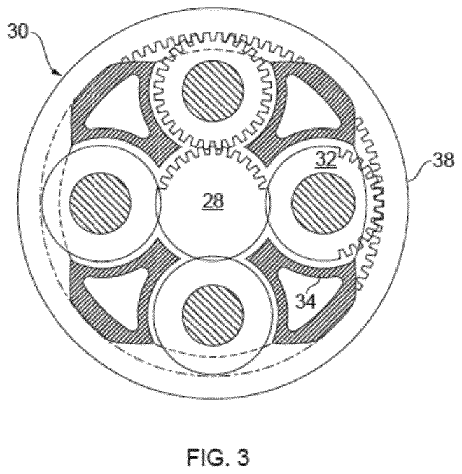

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox 30 may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

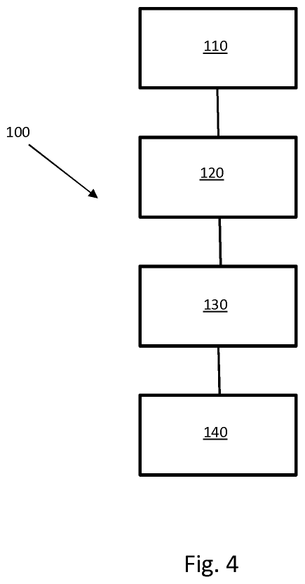

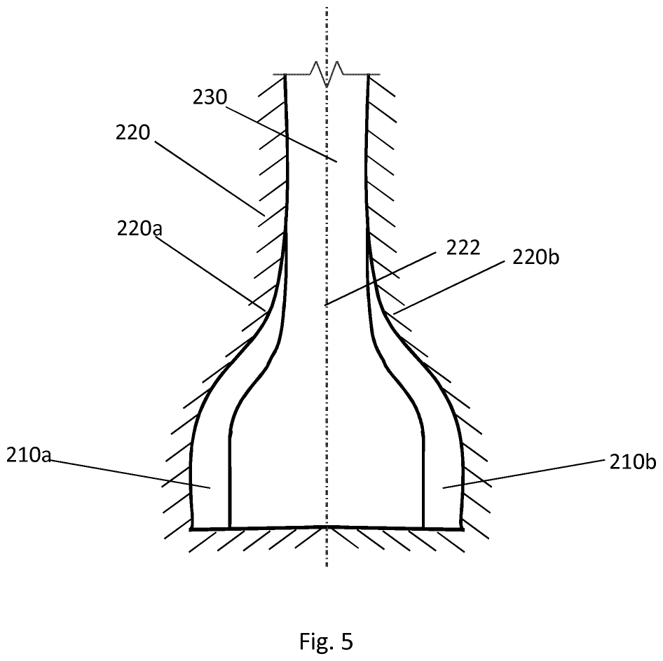

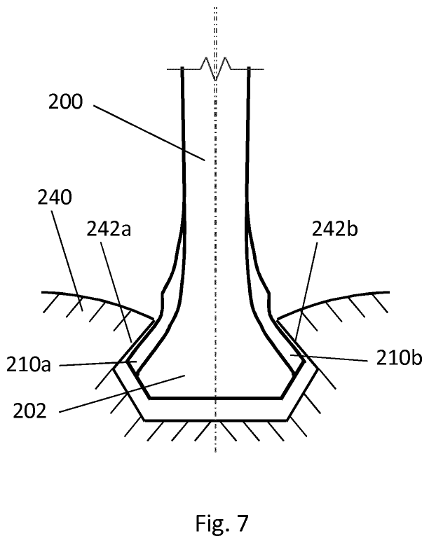

With reference to FIG. 4 the present disclosure relates to a method 100 of manufacturing an aerofoil structure 200 (partially shown in FIG. 7), such as a blade of fan 23. The method 100 comprises a first step 110 in which a pre-formed insert 210a (shown in FIG. 5) is provided. In a second step 120, the insert 210a is added into a mould 220 (shown in FIG. 5) for forming the aerofoil structure 200. In a third step 130, a composite constituent 230 (shown in FIG. 5) is added into the mould 220. Finally, in a fourth step 140 the composite constituent 230 is heated in the mould 220 to bond the insert 210a to the composite constituent 230.

FIG. 5 depicts at least an end of the mould 220 and a root end of the aerofoil structure 200 during manufacture. The mould 220 may split along axis 222 or along any other line to provide first and second mould parts 220a, 220b. The insert 210a may be placed into the mould 220, in particular the first mould part 220a. A further insert 210b may be placed into the mould 220, in particular the second mould part 220b. The inserts 210a, 210b may then form integral parts of the mould 220 ready to receive the composite constituent 230. The inserts 210, 210b may be pre-moulded to substantially the required shape before placement in the mould 220. The inserts 210, 210b may have been moulded in a different mould to mould 220 prior to insertion into mould 220.

The composite constituent 230 may then be placed on either the insert 210a or further insert 210b. For example, the method may comprise laying up the composite constituent into either or both of the mould parts 220a, 220b. The two mould parts 220a, 220b may be brought together. Accordingly, the insert 210a and further insert 210b may be provided either side of the composite constituent 230. The composite constituent 230 may form an elongate structure extending from the root to a tip of the aerofoil structure 200.

The inserts 210a, 210b may be machined prior to adding the inserts into the mould 220. For example, the inserts 210, 210b may be roughened, e.g. grit-blasted, prior to adding the inserts into the mould. In particular, the surfaces of the inserts 210a, 210b that face the composite constituent 230 in the mould 220 may be roughened. The inserts 210, 210b may also be degreased prior to placement in the mould 220. Such treatments may improve the subsequent adhesion to the composite constituent 230. However, to further enhance adhesion, the method may further comprise adding an adhesive layer between each of the inserts 210a, 210b and the composite constituent 230.

Once the inserts 210a, 210b and composite constituent 230 are in place in the mould 220, the components are heated, e.g. as part of an autoclave cure process. The composite constituent 230 may be pre-impregnated with a resin and heating the composite constituent in the mould 220 may thermoset the resin. In particular, the composite constituent 230 may comprise carbon fibre pre-impregnated with the resin. The resin (together with the adhesive layer if provided) may bond the inserts 210a, 210b to the composite constituent 230. Conveniently, the inserts 210a, 210b may be bonded to the composite constituent 230 in the same process as in which the composite constituent 230 is thermoset.

To avoid the inserts 210a, 210b deforming, the melting temperature of the inserts may be higher than the temperatures encountered in the mould 220 and higher than the melting temperature of the resin. The inserts 210a, 210b may be formed from a wear resistant material. By way of example, the inserts 210a, 210b may be formed from a polymer, such as Polyimide. In particular, the inserts 210a, 210b may be formed from 420X Polyimide provided by Icon Polymer. It is also envisaged that the inserts 210a, 210b may be formed from a non-polymer material, such as a metal or a ceramic or any other suitable material.

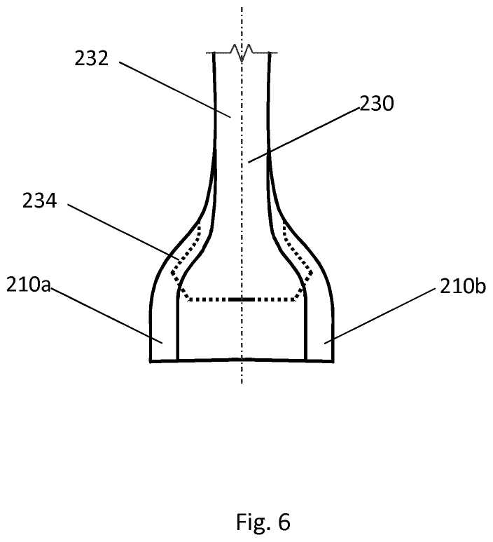

Referring to FIG. 6, once the heating and bonding has completed, an intermediate part 232 may be removed from the mould 220. The method 100 may further comprise machining the intermediate part 232 to remove excess material and form the aerofoil structure 200. For example, the intermediate part 232 may be machined along dotted line 234 to provide the required shape of the root of the aerofoil structure 200. The machining may remove portions of the inserts 210a, 210b and/or the composite constituent 230.

As shown, the inserts 210a, 210b may be elongate. The inserts may be curved and a midline (or either surface) of the inserts 210a, 210b may have a point of inflection between ends of the inserts 210a, 210b. Furthermore, the inserts 210a, 210b may taper at an end furthest from the root of the aerofoil structure 200 such that the inserts blend into the composite constituent 230. The dotted line 234 (along which the intermediate part 232 may be machined) may extend lengthwise along at least a portion of each insert 210a, 210b. As such, the machining process may reduce the thickness of the inserts 210a, 210b along at least a portion of their length.

FIG. 7 depicts the resulting aerofoil structure 200 with its root 202 received in a rotor disc 240, which may be made from titanium or an alloy thereof. As shown, the insert 210a and further insert, 210b are provided on a respective flank and further flank of the root 202 and facing a respective shoulder 242a and further shoulder 242b of the rotor disc 240. In particular, the inserts 210a, 210b may contact the shoulders 242a, 242b where the machining line 234 extends lengthwise along at least a portion of each insert 210a, 210b (i.e. where the thickness of the inserts 210a, 210b has been reduced). Machining in the area where the inserts 210a, 210b contact the shoulders 242a, 242b may help to provide the desired shape at the interface between the aerofoil structure 200 and the rotor disc 240.

The integrally formed inserts 210a, 210b advantageously provide an interface between the composite constituent 230 and the rotor disc 240. The inserts are conveniently provided during the manufacturing process of the composite constituent 230 and a separate layer is not required between the aerofoil structure 200 and the rotor disc 240. This reduces the cost and speeds up the manufacturing process. The inserts 210a, 210b may also be more readily repaired, e.g. by machining a worn insert to conform to a desired shape.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method of manufacturing an aerofoil structure for a gas turbine engine, wherein the aerofoil structure comprises a root configured to be received in a rotor disc (240) of the gas turbine engine, wherein the method comprises:
providing a pre-formed insert;
adding the insert into a mould for forming the aerofoil structure;
adding a composite constituent into the mould; and
heating the composite constituent in the mould to bond the insert to the composite constituent, the insert being provided at a flank of the aerofoil structure root that faces a shoulder of the rotor disc;
wherein the melting temperature of the insert is higher than the melting temperature of the resin.

2. The method of claim 1, wherein heating the composite constituent in the mould to bond the insert to the composite constituent forms an intermediate part, and the method further comprises machining the intermediate part to remove excess material and form the aerofoil structure.

3. The method of claim 1, wherein the composite constituent is pre-impregnated with a resin, and heating the composite constituent in the mould thermosets the resin.

4. The method of claim 1, wherein the composite constituent comprises carbon fibre pre-impregnated with a resin.

5. The method of claim 1, wherein the method further comprises:
adding a further insert into the mould, the insert and the further insert being provided on either side of the composite constituent.

6. The method of claim 1, wherein the method further comprises:
machining the insert prior to adding the insert into the mould.

7. The method of claim 1, wherein the method further comprises:
adding an adhesive layer between the insert and the composite constituent.

8. The method of claim 1, wherein the insert is formed from a polymer.

9. (canceled)

10. An aerofoil structure for a gas turbine engine, wherein the aerofoil structure comprises a root configured to be received in a rotor disc of the gas turbine engine, wherein the aerofoil structure is formed from a composite constituent and an insert moulded together, the insert being provided at a flank of the root of the aerofoil structure that faces a shoulder of the rotor disc.

11. The aerofoil structure claim 10, comprising a further insert being provided at a further flank of the root of the aerofoil structure that faces a further shoulder of the rotor disc.

12. The aerofoil structure claim 10, wherein the insert is made of a polymer.

13. The aerofoil structure of claim 10, comprising an adhesive layer between the insert and the composite constituent to enhance adhesion between the insert and the composite constituent.

14. A gas turbine engine for an aircraft comprising:
an engine core comprising a turbine, a compressor, and a core shaft connecting the turbine to the compressor; and
a fan located upstream of the engine core, the fan comprising a plurality of the aerofoil structures according to claim 10.

15. The gas turbine engine of claim 14, wherein the gas turbine engine further comprises:
a gearbox that receives an input from the core shaft and outputs drive to the fan so as to drive the fan at a lower rotational speed than the core shaft.

16. The gas turbine engine of claim 14, wherein:
the turbine is a first turbine, the compressor is a first compressor, and the core shaft is a first core shaft;
the engine core further comprises a second turbine, a second compressor, and a second core shaft connecting the second turbine to the second compressor; and
the second turbine, second compressor, and second core shaft are arranged to rotate at a higher rotational speed than the first core shaft.

17. (canceled)

18. The method of claim 8, wherein the polymer comprises polyimide.

19. The aerofoil structure claim 12, wherein the polymer comprises polyimide.

20. The aerofoil structure claim 11, wherein at least one of the insert and the further insert is made of a polymer.
